(19) United States
(12) Patent Application Publication
(10) Pub. No.: US 2011/0025050 A1
(43) Pub. Date: Feb. 3, 2011

(54) CONNECTION SYSTEM FOR DOUBLE-WALLED PIPES

(76) Inventor: Gernold Holler, Wittingen (DE)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/739,732

(22) PCT Filed: Oct. 24, 2008
(86) PCT No.: PCT/DE2008/001731

§ 371 Date: Oct. 22, 2010

(30) Foreign Application Priority Data
Oct. 25, 2007 (DE) 10 2007 051 436.2

(51) Int. Cl. F16L 25/00

(52) U.S. Cl. 285/333

(57) ABSTRACT

The invention relates to a connection system for double-walled pipes (1, 2) comprising an inner pipe (12, 22) made of a stainless steel and an outer pipe (11, 21) which surrounds the inner pipe (12, 22) and has a greater tensile strength than the inner pipe (12, 22), wherein threads (13, 23) are formed at the ends of the outer pipe (11, 21), and also comprising a screw-type sleeve (3) with internal threads (31, 32) which correspond in terms of design to the external threads (13, 23), and comprising a sealing ring (4) which is arranged in the sleeve (3), is formed from a stainless material and, in the screwed-on state, seals the sleeve (3) with respect to the medium transported through the inner pipe (12, 22).

The invention relates to a connection system for double-walled pipes with an inner pipe made of a stainless material and an outer pipe surrounding the inner pipe.

Double-walled pipes are used to combine advantageous properties of different materials, in particular in order on the one hand to form pipes which are as stable as possible and on the other hand to be able to convey aggressive or corrosive media. Double-walled pipes are in this case manufactured by way of internal high-pressure forming, for example, in which an inner pipe is inserted into an outer pipe and both pipes are mechanically connected to each other by being expanded while an internal pressure is applied. Subsequently, the inner pipe is welded to the outer pipe at the pipe ends by a seal weld seam. The seal weld seam at the front sides of the pipes secures the pipes to one another, so that double-walled pipes of this type can be laid only using specific laying methods and cannot be unwound from large drums, for example. Furthermore, it is not possible to shorten and adapt the lengths of the pipes without destroying the seal seam, so that a seal seam has to be rewelded when cutting to length the double-walled pipe.

Pipes made of stainless materials are often less suitable for use under high tensile forces, as these materials generally have insufficient strength and begin to flow under high tensile loads.

In the past, a high-strength, stainless steel had to be used in order to be able to use stainless pipes under high tensile forces. These steels have the drawbacks of being very difficult and expensive to obtain. Furthermore, high-strength, stainless steels of this type often cannot be used before they have been additionally further treated so as to increase their strength. In most cases, the strength is increased at the cost of elongation.

The use of what are known as black steels is not possible in many cases, as they cannot be used under corrosive conditions, in particular for the transportation of corrosive media.

A combination of both materials, i.e. stainless steels as the inner pipe and high-strength black steels as the outer pipe, solves this problem. Unfortunately, these pipes are not readily connectable to one another, as it is often not possible to weld the pipes, as welding is a heat treatment that is accompanied by a loss of strength. For this reason, pipes of this type have to be screwed together. A pipe connection for double-walled pipes is known from DE 102 57 224 A1. However, this necessitates the use of stainless pipe end pieces which on the one hand are expensive and on the other hand cause problems when screwing-in for a vertical use of the pipes, as in uses of this type relatively high perpendicular loads and tensile forces occur and the pipe end pieces, which are made of stainless steel, cannot transmit high tensile forces.

It is not possible to replace the pipe end pieces made of special steel with pipe end pieces made of simple steels, as it is not possible to ensure protection of this component from corrosion.

The object of the present invention is to provide a connection system on the one hand allowing high tensile forces to be transmitted and on the other hand allowing sufficient protection from corrosion to be provided.

According to the invention, this object is achieved by a connection system having the features of claim 1. Advantageous configurations and developments of the invention are recited in the sub-claims.

The connection system according to the invention for double-walled pipes with an inner pipe made of a stainless material, in particular a stainless steel, and an outer pipe which surrounds the inner pipe and has a greater tensile strength than that of the inner pipe makes provision for the formation of threads at the pipe ends of the outer pipe and the arrangement, in a screw-type sleeve with inner threads which are formed so as to correspond to the outer threads, of a ring seal which is formed from a stainless material and seals, in the screwed-in state, the sleeve from the medium transported through the inner pipe. In this way, it is possible on the one hand to transmit high tensile forces via the outer pipe and on the other hand to carry out a corrosion-resistant transition between the pipe ends in that the ring seal provides a transition which is as smooth as possible between the pipe ends and, in addition, protects the sleeve from contact with the media to be conveyed in the inner pipe.

A development of the invention provides for the ring seal to be arranged centrally in the sleeve, preferably fixed within the sleeve, wherein it is for example possible to arrange within the sleeve a groove or depression into which the ring seal is fitted. In addition, fixing can be carried out mechanically, by screwing, or in a material-uniting manner, by welding or adhesive bonding.

The ring seal is in this case preferably made of the material of the inner pipe, i.e. of a stainless steel; alternatively, the ring seal can also be made of a plastics material.

The ring seal can be provided with projections or notches at its front sides in order to form sealing elements which, in the fitted state, rest against the front sides of the pipe ends or corresponding connection parts and prevent the medium from issuing through the screw-type sleeve.

The ring seal can in this case be arranged and embodied in such a way that its front sides rest, in the screwed-in state, against the pipe ends of the screwed-in pipes, so that there is direct contact between the pipe ends both of the outer pipe and of the inner pipe and the ring seal. In this case, the front sides of the inner pipe can either be flush with the outer pipe or end before the pipe end of the outer pipe. From this, a shoulder, which can be bridged via the ring seal, is then formed between the pipe end of the inner pipe and the inner diameter of the outer pipe.

Instead of a bridging through the ring seal, it is possible for a coupling piece, which is adapted to the particular closing contour of the pipe ends, for example, to be arranged between the ring seal and the pipe. This coupling piece is also made of a stainless material, preferably of a material of the same type as the inner pipe.

The inner diameters of the ring seal and the coupling piece correspond substantially to the inner diameter of the inner pipe in order to ensure as undisturbed a flow as possible through the pipeline.

For better sealing, the threads are conically embodied; this additionally facilitates screwing-in. Alternatively, a cylindrical configuration of the threads is provided.

The sleeve is preferably made of a material having at least the strength of the material of the outer pipe; likewise, provision is made for the sleeve to be formed from the same material as the outer pipe, for example from a high-strength steel.

In order to prevent the ring seal from twisting during fitting thereof, form-fitting elements, which prevent a relative movement of the ring seal and coupling piece or pipe end in the circumferential direction, are embodied on the ring seal and also the coupling piece or the pipe end.

An exemplary embodiment of the invention will be described hereinafter in greater detail with reference to the appended drawings, in which:

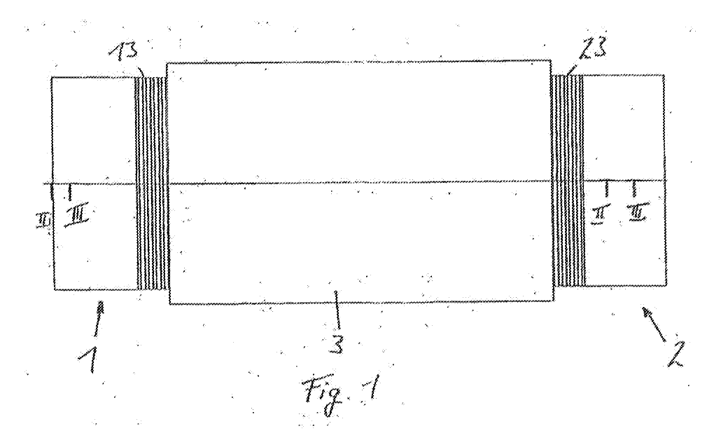

FIG. 1 is a plan view onto two pipes connected via a sleeve;

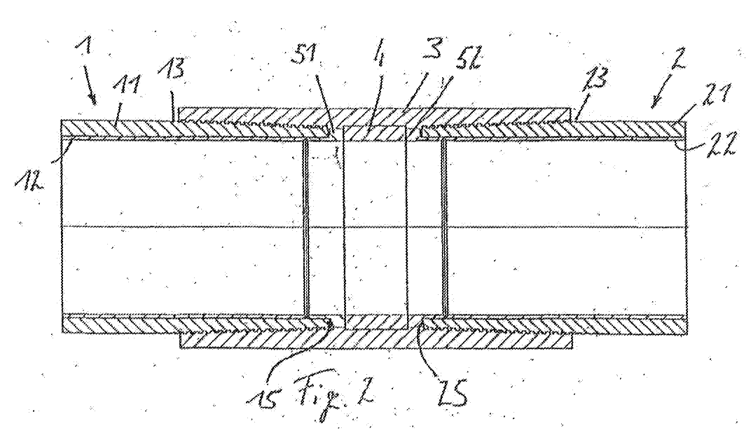

FIG. 2 is a sectional illustration of the pipe connection according to FIG. 1;

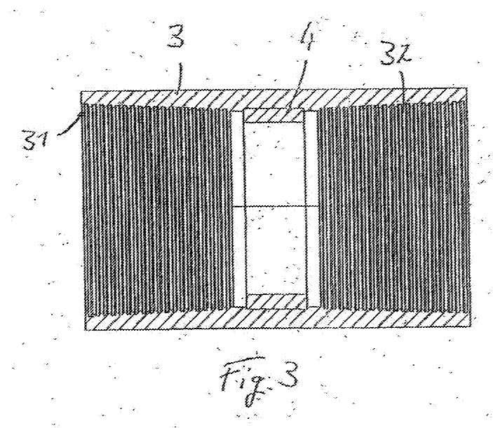

FIG. 3 is a sectional illustration through a sleeve;

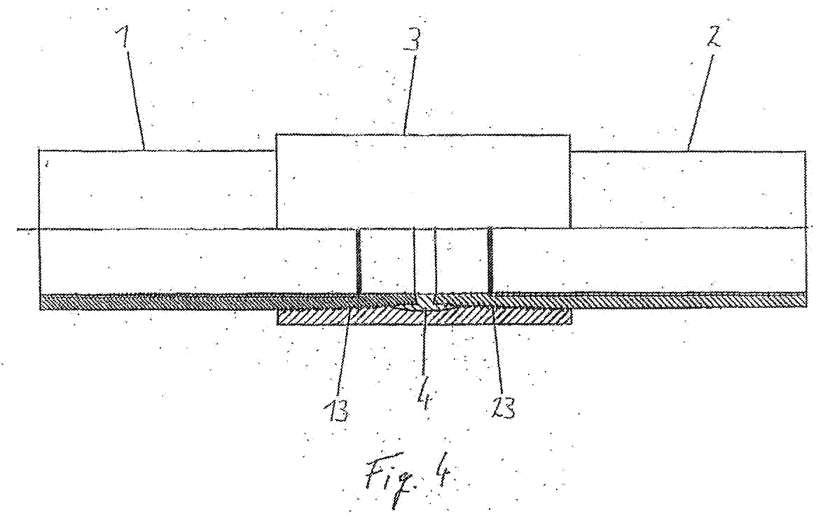

FIG. 4 is a partially cut-away view of a variant;

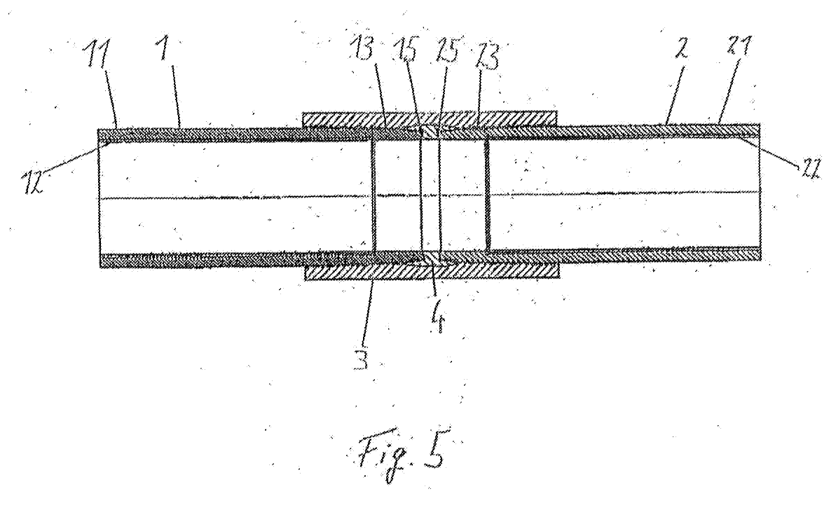

FIG. 5 is a total sectional illustration according to FIG. 4; and also

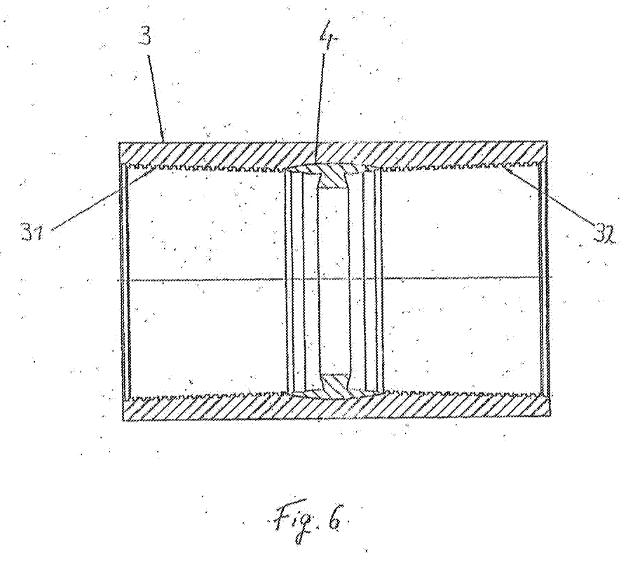

FIG. 6 is an enlarged partial illustration of a sleeve with a ring seal.

FIG. 1 shows two pipes 1, 2 with their pipe ends. Outer threads 13, 23 are arranged at the pipe ends. Both pipes 1, 2 are joined together via a screw-type sleeve 3.

FIG. 2 is a sectional illustration showing that the two pipes 1, 2 are embodied in a double-walled manner and have an outer pipe 11, 21 and also an inner pipe 12, 22. The inner pipe 12, 22 is made of a stainless material, preferably steel, whereas the outer pipe 11, is made of a high-strength material, preferably black steel. Conically tapering threads 13, 23 are formed at the end regions of the pipes 1, 2. In the illustrated embodiment, the inner pipe 12, 22 ends before the pipe ends 15, 25 of the outer pipes 11, 21.

The two pipes 1, 2 are joined together via the screw-type sleeve 3. Outwardly widening, conical inner threads 31, 32, which correspond to the outer threads 13, 23 of the pipes 1, 2, are formed, as may be seen in FIG. 3, within the sleeve 3. A ring seal 4, which is secured against axial displacement by form-fitting elements, for example in the form of a peripheral groove into which the ring seal 4 is inserted, is fitted centrally within the sleeve 3. In addition to mechanical securing via the groove, the ring seal 4 can be adhesively bonded, soldered or welded; additional screwing-in may also be provided.

In the illustrated exemplary embodiment of FIG. 2, coupling pieces 51, 52, which rest against the front sides of the ring seal 4, are arranged between the ring seal 4 and the pipe ends 15, 25. On the side remote from the ring seal 4, the coupling pieces 51, 52 are embodied flush with the inner pipes 12, 22 and outer pipes 21, 22.

The material of the sleeve 3 is the same material as the material of the outer pipes 11, 21, whereas the material of the ring seal 4 and also if appropriate of the coupling pieces 51, 52 corresponds to that of the inner pipes 12, 22.

In order not to jeopardize by changes in cross section a transmission of force on one pipe 1 to the other pipe 2 via the sleeve 3, the recess for inserting the ring seal 4 in the sleeve 3 is not larger than the depth of the inner thread 31, 32 of the sleeve 3.

Following the insertion into the sleeve, further sealing elements can be attached to the front sides of the ring seal 4 by machining and forming. This can also result in changes in profile and cross section. The ring seal 4, together with the coupling pieces 51, 52 which may be present, ensures with the adapted contours that a continuous, gap-free surface made of a stainless material is produced as soon as all the components of the system are screwed together. The continuous surface consists of the inner pipes 12, 22, the ring seal 4 and if appropriate the coupling pieces 51, 52. The surface made of stainless material, which surface is impervious to the transported medium on account of the compression, ensures that no corrosion can take place at the inner side of the sleeve 3. At the same time, a similar, sufficiently secure connection is produced that can transmit the tensile forces which occur between the pipes 1, 2, as a result of which screwing-in of this type can also be used for a perpendicular installation of the pipes 1, 2, for example in drilling projects.

FIG. 4 is a partial sectional illustration of two connected pipes 1, 2 which are joined together via a sleeve 3. Both pipes 1, 2 have outer threads 13, 23 which are drawn toward the ring seal 4, which is arranged at the center of the threaded sleeve 3, via corresponding inner threads of the sleeve 3. A coupling piece is not shown in the illustrated exemplary embodiment. In this case too, the threads 13, 23 are conically embodied and taper toward the ring seal 4; alternatively thereto, cylindrical thread formations are also provided and possible.

FIG. 5 is a complete sectional illustration of the variant according to FIG. 4. The construction of the connection illustrated in FIG. 5 corresponds substantially to the construction according to figure 2. Like reference numerals denote like components. In contrast to FIG. 2, no coupling piece 51, 52 is provided in FIG. 5; instead, the ring seal 4 rests directly against the pipe ends 15, 25 and in this way seals the sleeve 3 from the transported medium. The transported medium enters into contact with the respective outer pipe 11, 21 over a short region in which the inner pipe 12, 22 does not cover the outer pipe 11, 21. The inner diameter in this region corresponds to the inner diameter of the inner pipe 12 and of the ring seal 4, allowing a substantially undisturbed flow of the transported medium to be ensured.

FIG. 6 is an enlarged sectional illustration of the threaded sleeve 3. The ring seal 4 is centrally fastened within the sleeve 3 and has a rounded contour at the outer side facing the sleeve 3. A web protrudes inward, thus producing a mushroom-shaped cross section. An undercut which is effective in the radial direction is formed by this cross section, thus producing a self-reinforcing pressing of the ring seal 4 in the region of the web against the contact edge of the pipe end 15, (not shown). The pipe ends 15, 25 are equipped with an inwardly directed bevel, so that the pipe ends 15, 25 penetrate the ring seal 4 and coverage, which is present in the axial direction, occurs instead of smooth abutment.

Alternatively to the configuration without a coupling piece, the geometry of the ring seal 4 can also be utilized with a coupling piece, the respective front-side end of the coupling pieces 51, 52 having a contour corresponding to the cross section of the ring seal 4.

1-13. (canceled)

14. A connection system for double-walled pipes (1, 2) with an inner pipe (12, 22) made of a stainless material and an outer pipe (11, 21) which surrounds the inner pipe (12, 22) and has a greater tensile strength than that of the inner pipe (12, 21), wherein threads (13, 23) are formed at the pipe ends of the outer pipe (11, 21), and also a screw-type sleeve (3) with inner threads (31, 32) which are formed so as to correspond to the outer threads (13, 23) and a ring seal (4) which is arranged in the sleeve (3), is formed from a stainless material and seals, in the screwed-in state, the sleeve (3) from the medium transported through the inner pipe (12, 22), characterized in that the inner pipe (12, 22) ends before the pipe end of the outer pipe (11, 21) and a coupling piece (51, 52), which is made of a stainless material and on the side remote from the ring seal (4) is embodied flush with the inner pipes (12, 22) and the outer pipes (11, 21), is arranged between the ring seal (4) and the pipe end (15, 25).

15. The connection system as claimed in claim 1, characterized in that the ring seal (4) is arranged centrally in the sleeve (3).

16. The connection system as claimed in claim 1, characterized in that the ring seal (4) is fixed in the sleeve (3).

17. The connection system as claimed in claim 1, characterized in that the ring seal (4) is made of the material of the inner pipe (12, 22).

18. The connection system as claimed in claim 1, characterized in that the ring seal (4) is provided with projections or notches at its front sides.

19. The connection system as claimed in claim 1, characterized in that the inner diameter of the ring seal (4) corresponds to the inner diameter of the inner pipe (12, 22).

20. The connection system as claimed in claim 1, characterized in that the threads (13, 23; 31, 32) are embodied conically or cylindrically.

21. The connection system as claimed in claim 1, characterized in that the sleeve (3) is made of a material having at least the strength of the material of the outer pipe (11, 21).

22. The connection system as claimed in claim 1, characterized in that corresponding form-fitting elements, which prevent a relative movement of the ring seal (4) and coupling piece (51, 52) or pipe end (15, 25) in the circumferential direction, are embodied on the coupling piece (51, 52) or the pipe end (15, 25) and the ring seal (4).

23. The connection system as claimed in claim 1, characterized in that the inner pipe (12, 22) is made of a stainless steel.
